(19) United States
(12) Patent Application Publication
(10) Pub. No.: US 2012/0072032 A1
(43) Pub. Date: Mar. 22, 2012

(54) METHODS AND SYSTEMS FOR ENVIRONMENTAL SYSTEM CONTROL

(76) Inventors: Kevin J. Powell, Annapolis, MD (US); Daniel Gilstrap, Midvale, UT (US)

(21) Appl. No.: 13/240,868

(22) Filed: Sep. 22, 2011

Related U.S. Application Data
(60) Provisional application No. 61/385,203, filed on Sep. 22, 2010.

(51) Int. Cl. G05D 23/19; G06K 9/00

(52) U.S. Cl. 700/278; 382/103; 700/276

(57) ABSTRACT

Methods, systems, and apparatuses for environmental system controls are provided. A number of human subjects present within a space is determined, which may include counting the human subjects and/or determining a thermal mass of the human subjects. An impact upon an environmental factor by the present human subjects upon the space is determined. Environmental conditioning equipment is controlled based on the determination.

This application claims the benefit of U.S. Provisional Application No. 61/385,203, filed on Sep. 22, 2010, which is incorporated by reference herein in its entirety.

### BACKGROUND OF THE INVENTION

1. Field of the Invention

The present invention relates to environmental control systems.

2. Background Art

The human micro-environment: Environmental Control Systems (ECSs) are currently engineered to provide heating, ventilation, and cooling in order to maintain a comfortable environment for humans. ECSs in use today include sensors to detect a variety of environmental factors, heat exchangers in combination with air handlers (fans) on the interior of the building, exterior heat exchange equipment (compressors, chillers, etc), and control logic. These current ECSs are designed with sensors monitoring the environment in locations that are convenient for construction (such on as a wall, inside an air duct, etc.), but are not necessarily located in the spaces where humans are typically located. The reality of the current design is one that should consider three different micro-spaces—the conditioned air input, the human desiring comfort, and the environmental sensing micro space. Because there is space between these micro-environments and air flow, environmental conditioning will take some time period to move from one micro-environment to the other. A result is that there is a latent system response that can also lead to over compensation and cyclical swings. Such swings may be experienced due to the latency in time it takes for the impact of humans in a micro-environment to affect a more remote temperature sensor, and due to the time it takes for the heating, ventilation, and cooling systems to force conditioned air from vents in a remote micro-environment back to the human subjects and beyond to the original sensing micro-environment. Because these ECSs are also frequently designed with only a temperature sensor, there may be no compensation for other effects of the human upon the environment, such as the addition of carbon dioxide, the removal of oxygen, the addition of humidity, and/or other introductions of airborne particles such as viruses, bacteria, and other not so harmful odors herein defined as environmental factors. As a result of current ECSs design, human subjects experience cyclical swings of the environmental factors around their own personal micro-environment, which misses an intent of the original design to control the environment to a tolerance that maintains a quality comfort level for the human body. As such, current ECS designs miss a goal that was set for their design.

Energy and cost savings: Simple and traditional temperature sensors used in ECSs have recently been supplemented with timers and more complex control logic. Operating an ECS requires the use of energy, which in turn costs some amount of money. In some periods of recent time, energy costs have increased substantially. As such, efforts are being made to reduce costs of operation to an amount that justifies at least the purchase of the new ECS. A common technique to introduce energy savings is via a simple timer in concert with the temperature sensor. The timer effectively sets periods of time whereby a control element has two (or more) modes of operation—an occupied and an unoccupied (a.k.a. setback) state. The goal of these ECSs is to turn off usage of power consuming ECSs when the corresponding conditioned areas are not utilized by humans. These ECSs cannot typically completely turn off conditioning as there is a certain amount of time necessary to re-condition a space in preparation for a future use, and these limits are realized in system design and implementation or usage. As a result, current energy saving systems typically adjust setpoints (temperature targets) only by several degrees so as to allow for a reasonable time period for return to a comfortable condition when needed (ideally 15-30 minutes of conditioning). Most systems utilize the timer for setting these time periods of activity/inactivity (normal/setback) and are referred to as “programmable thermostats.” A basic premise in traditional designs is a very consistent human presence in the spaces that implement the energy saving controls. Unfortunately, due to the very nature of humans, humans do not always follow the “clock” regularly. In addition, some larger commercial spaces are utilized quite randomly. Such larger commercial spaces include but are not limited to conference rooms, auditoriums, convention spaces, movie theaters, and other public venues where start times and/or end times are not completely predicable. As one may expect, when there is human presence in areas that are currently configured as inactive, or in setback mode, the human(s) enter an environment that is not properly conditioned. The humans will desire to seek out either the control element or an operator familiar with the control element, or will simply suffer through the event in an otherwise unconditioned or minimally conditioned environment.

Since the introduction of the timer and setback technology, other control and corrective actions by operators have become popular as a result of the complications of the timer technology and the human interaction with this technology. The initial configuration of the timer is made to produce a most efficient use of energy. Subsequently, the timer or configuration settings are modified by those not comfortable in the space when the system is in a setback (inactive) mode. For example, the initial configuration of 9 am to 5 pm may be extended to 6 am to 9 pm, or the setback of 10 degrees may be reset to 4 degrees (or both). These modifications then lead to inefficiencies, sometimes costly. When cost is reviewed, the system is reset, and may be protected against modification (e.g., locked physically, or by a passcode in some cases). This negative feedback loop can continue until such time as the unforeseen human event entering an unconditioned environment without an ability to correct the situation (e.g., no keys, no password, and no operator staff available to correct the situation). Further complicating this awkward condition, is that simple timers, which are not connected to a central timer source, have a tendency to drift from a correct time, to lose some programming with battery and power loss, and are not kept up to the correct time during daylight savings adjustments.

Unfortunately, in these conditions, after some period of use and encountering of an unconditioned space by persons, these setbacks are typically turned off. If the programmable thermostat is incorrectly programmed, has a time that is not correct, or is simply too difficult to correctly program, the person managing the space may disable the energy savings to quickly satisfy the need of a properly conditioned space for human occupation. These systems often fall back to the functionality of a standard thermostat, defeating the original purpose and financial justification of their installation.

Detection of human presence: Some ECSs have recently attempted to address the issue of saving energy while avoiding the pitfalls of implementing timers, such as by detecting the presence of humans in the space. Occupancy sensing has been recently introduced, and is not yet in widespread usage to address the infrequent use of space. A goal is to setback or turnoff conditioning in spaces that are not occupied, while being able to rapidly and automatically return to a normal mode of operation when detecting the human presence. These systems are typically designed with a motion sensor in combination with the temperature sensor, and, in some cases, with a timer as well. The logic is rudimentary and simply sets the mode of operation into a normal state whenever motion is detected. While the current occupancy sensor design does automatically detect a human by sensing movement, it does not accommodate the wide variance of impact from one human to many humans upon a space. It also has a good potential for introducing larger overruns in conditioning of the micro-environment around the human subject due to the typically larger temperature range from a non-occupied state (setback) to an occupied state (normal), and the corresponding latency issues that have been address previously in this section.

Additionally, the use of a traditional occupancy sensor is not necessarily fitting of its intended use, thereby introducing unwanted side effects. Occupancy sensors have been developed over many years related to the security industry. These sensors are meant to detect motion, not necessarily presence. For example, the design may likely sense human motion around a space. However, if the human were to stop motion, the sensors stop detection. A more popular example is when occupancy sensors are utilized in lighting applications. Most people are familiar with a space, when entered, automatically lights are turned on. The sensor problem is realized when that same system turns lights off while humans are still present—simply because of the condition that humans are no longer moving (but still present). With regard to environmental controls, the occupancy sensor has a tendency to incorrectly setback environmental controls in the presence of humans, whether in a commercial space (e.g., with an audience attentive to a presentation), or a residential space (e.g., residents watching television or sleeping at night). The result is that the control system does not maintain a constant micro environment for the human, and is not desirable.

All of these described traditional ECSs are not properly designed to maintain a constant desired target environment around any humans that are present. As a result, most are typically partially or totally disabled over time, resulting in an original inefficient ECS.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and apparatuses for environmental controls are described herein. One or more environmental sensors detect and/or allow for the accurate prediction of the impact of one or more human presence(s) upon one or more environmental factors of particular interest in a target space to be conditioned. The sensor(s) is/are an input to a control logic that determines a type and amount of conditioning to apply to the target space. The control logic takes one or more variables into account when determining the type and amount of conditioning to apply to the space. Examples of the variables include a present environment (in one or many factors), a current human presence demand of zero or more (in one or many factors), a current human impact (in one or many factors), a historical trend analysis of the space without human impact (in one or many factors), and/or an ability of the controlled equipment to impact the target environment (in one or many factors). For each environmental factor of interest, the control logic understands the current environment, the desired target environment, and how much impact, historically, environmental control equipment to be controlled can change the environment. The control logic calculates a recovery response (e.g., if changing to a non-zero human presence), and a residual requirement during the period of human presence.

Environmental factors to be addressed may change dramatically from application to application, with consideration toward national or local required standards, desired air quality, and system complexity and cost. Temperature, humidity, and carbon dioxide are example factors that may be regulated. However, oxygen, bio-contaminants such as bacteria and virus, and radiant sources (sunlight) may also be addressed in some higher end system design embodiments. Additionally, ‘stale air’ can and is contemplated to be considered an environmental factor, as opposed to ‘fresh air’. Currently, stale air can be considered resolved by air circulation. However, current technology does not cleanly define ‘stale air’, nor is a detector of stale air present. Furthermore, an environmental factor should be considered, and is contemplated in embodiments to also include all such factors of an environment that are controllable and detectable to humans, which include four of the five traditional senses (less taste). A) Eyes sense the light level (amplitude) and color (frequency) of light; B) ears sense the sound level (amplitude) and tone (frequency) of sound; C) skin senses the temperature and radiant heating as well as the impact of moisture content of the air; D) the nose senses smells, including odors (both good and bad), ‘stale’ air versus ‘fresh’ air, etc. As mentioned above, in addition to environmental factors that can be sensed by human senses, are properties of the environment that are required to be at certain levels, such as air oxygen content, air carbon dioxide content, air ozone content and so on. Each of these environmental factors can be sensed or predicted, and controlled (directly or indirectly) in embodiments.

The environmental controls interface environmental control equipment that provides environmental conditioning of one or more environmental factors into the space that is the target for human presence. In addition, systems that more directly impact or more efficiently impact one or more of the environmental factors described herein may be controlled. For example, ‘stale’ air may be controlled by the introduction of exterior air, since this is technologically feasible and reasonably efficient, and a future control may be applied to a system that removes carbon dioxide and/or adds oxygen without utilization of exterior air. Equipment manufacturers may use an interface through their own sensor device so that the sensor device may implement other trade secret protection algorithms, such as short cycling, defrost, etc. These algorithms may be accommodated within embodiments, thus replacing the need for a separate and duplicate sensor unit.

In one implementation, a method for environmental system control is provided. A number of human subjects present within a space is counted. An impact upon an environmental factor by the present human subjects upon the space is determined Environmental conditioning equipment is controlled based on the determination.

In one aspect, optical image analysis of a plurality of images of entrances to the space may be performed to determine a presence and a direction of travel of one or more human subjects. Alternatively, optical image analysis of a single image of the space may be performed to determine a presence of one or more human subjects.

In another implementation, an environmental control system is provided. The environmental control system includes at least one sensor and an environmental impact processor. The at least one sensor may count a number of human subjects present within a space. The processor is configured to determine an impact upon an environmental factor by the present human subjects upon the space. Environmental conditioning equipment is controlled by control signals generated by the processor based on the determination.

In another implementation, another method for environmental system control is provided. A collective impact upon an environmental factor of one or more human subjects present within a space is determined. Environmental conditioning equipment is controlled based on the determination.

In one aspect, thermal image analysis of a plurality of images of entrances to the space may be performed to determine impact upon an environmental factor and direction of travel of the one or more human subjects. Alternatively, thermal image analysis of a single image of the space may be performed to determine a collective impact upon an environmental factor of the one or more human subjects.

In another implementation, another environmental control system is provided. The environmental control system includes an environmental impact processor. The processor is configured to determine a collective impact upon an environmental factor of one or more human subjects present within a space. Environmental conditioning equipment is controlled by the processor based on the determination.

In another implementation, another method for environmental system control is provided. One or more environmental factor requirements of a plurality of human subjects present within a space is/are determined Environmental conditioning equipment is controlled based on the determination.

In one aspect, an analysis of one or more thermal images of the human subjects may be performed to determine the environmental factor requirements. Alternatively, an analysis of an activity level of the human subjects may be performed to determine the environmental factor requirements. In still another aspect, the activity level may be determined by analysis of a plurality of optical images of the human subjects. In still another aspect, the activity level may be determined by analysis of one or more thermal images of the human subjects. In a further aspect, the environmental factor requirements may be adjusted by additional analysis of external environmental factors incident to the space.

In another implementation, another environmental control system is provided. The environmental control system includes an environmental impact processor. The processor is configured to determine one or more environmental factor requirements of a plurality of human subjects present within a space. Environmental conditioning equipment is controlled by the processor based on the determination.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 depicts a traditional environmental conditioning system and space.

FIG. 2 illustrates an individual room details with air pathways and conditioning delays.

FIG. 3A shows a timing chart indicating temperatures at different locations and times during active environmental conditioning.

FIG. 3B shows a timing chart indicating temperatures at different locations and times during active environmental conditioning, according to an example embodiment.

FIG. 4 shows an environmental control system, according to an example embodiment.

FIG. 5 shows a block diagram of a visible light human detector/sensor, according to an example embodiment.

FIG. 6 shows a process for the control of an environmental conditioning system, according to an example embodiment.

FIG. 7A shows a flowchart providing a process for the determination of the efficiencies of an environmental conditioning system as applied to the control of an environmental factor, according to an example embodiment.

FIG. 7B depicts a graph of an environmental factor on environmental conditioning, according to an example embodiment.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

System and methods for environmental controls are described herein. Furthermore, systems and methods for environmental sensing are also described. The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

### Example Embodiments

The example embodiments described herein are provided for illustrative purposes, and are not limiting. Furthermore, their structural and operational embodiments, including modifications, alterations, will become apparent to persons skilled in the relevant art(s) from the teachings herein.

As described in the background section, current ECSs cause human subjects to experience cyclical swings in the environmental factors around their own personal micro-environment. As a result, the environment is not controlled to a tolerance that maintains a quality comfort level for the human body. As such, in embodiments, an ECS is provided that can ensure that the micro environment that surrounds the human subject(s) is the target of the ECS, rather than the micro-environment surrounding the sensors or conditioned air output. The ECS can directly detect the micro-environment and/or predict the effects of the human on their micro-environment in order to compensate in advance of any under or overrun. The prediction of human impact provides constant environmental conditioning (thermal and/or air quality) requirements to compensate for the human impact and desired target environment. Such requirements may be used by the ECS to control other environmental control elements that will both bring to current (if the ECS was inactive) and maintain the target environmental factors.

Furthermore, as described above, programmable thermostats with complex logic to save energy are frequently incorrectly programmed, have a time that is not correct, are too difficult to correctly program by a typical person, and/or may have other disadvantages. In such case, a person managing a space may disable the complex features of the thermostat, causing the thermostat to function as a standard thermostat, defeating the original purpose and financial justification. In an embodiment, an ECS is configured to learn patterns and adjust to the human environment automatically, while also accurately detecting a human presence for return to normal mode operation. In an embodiment, an ECS may be intelligent enough to know what date, time of day, and normal schedules are without a need for a maintenance programming.

Another form of energy savings in some power utility areas is time of day rating. Some power utilities offer a reduced usage rate during off peak periods. In an embodiment, an ECS may be configured to defer full conditioning of unused space to a lesser cost period. For example, if an area to condition is unused with a current temperature just reaching 79, has a target temperature of 78 degrees (setback cooling), and the current time is 15 minutes from a reduced rate period, the ECS may defer conditioning for an additional 15 minutes to achieve a lower cost for conditioning of the space.

Still further, as described above, conventional systems do not properly detect the presence of humans because they require the humans to be in motion to be detected. In embodiments, an ECS is provided that detect the presence of humans rather than detecting motion.

In embodiments, ECSs are provided that target environmental factors and control the micro-environment around any present humans in an automated manner, while providing an energy efficient mode for the occasions that the target space has no human occupants and/or reduced (including no) need of environmental conditioning. Embodiments for ECSs are described for use in the control of an indoor environment through interaction with an existing system with thermostatic control, or through a more direct connection in replacement of the standard thermostatic control.

Furthermore, for purposes of illustration, example embodiments are described herein for an environmental control system related to thermal control. However, embodiments are applicable to control many other environmental factors, for example CO2 (carbon dioxide), oxygen, humidity, odors, fragrances, radon, and/or other sensed environmental conditions such as light intensity and sound volume. Such applicability to other environmental factors will be apparent to persons skilled in the relevant art(s) from the teachings herein, and is within the scope and spirit of embodiments of the present invention.

Environmental factors to be addressed may change dramatically from application to application, with consideration toward national or local required standards, desired air quality, and system complexity and cost. Temperature, humidity, and carbon dioxide will likely be the most popular factors to regulate. However, oxygen, bio-contaminants such as bacteria and virus, and radiant sources (sunlight) may also be addressed in higher end system design. Additionally, though not well defined, ‘stale air’ can and is anticipated to be considered an environmental factor, it's opposite being ‘fresh air’. Currently, stale air can be considered resolved by air circulation, however, current technology does not cleanly define ‘stale air’, nor is a detector of stale air present. Furthermore, an environmental factor should be considered, and is anticipated in embodiments to also include all such factors of an environment that are controllable and detectable to humans, which include four of the five traditional senses (less taste). A) Eyes sense the light level (amplitude) and color (frequency) of light; B) ears sense the sound level (amplitude) and tone (frequency) of sound; C) skin senses the temperature and radiant heating as well as the impact of moisture content of the air; D) the nose senses smells, including odors (both good and bad), ‘stale’ air versus ‘fresh’ air, etc. As mentioned above, in addition to environmental factors that can be sensed by human senses, are properties of the environment that are required to be at certain levels, such as air oxygen content, air carbon dioxide content, air ozone content and so on. Each of these environmental factors can be sensed or predicted, and controlled (directly or indirectly) in embodiments.

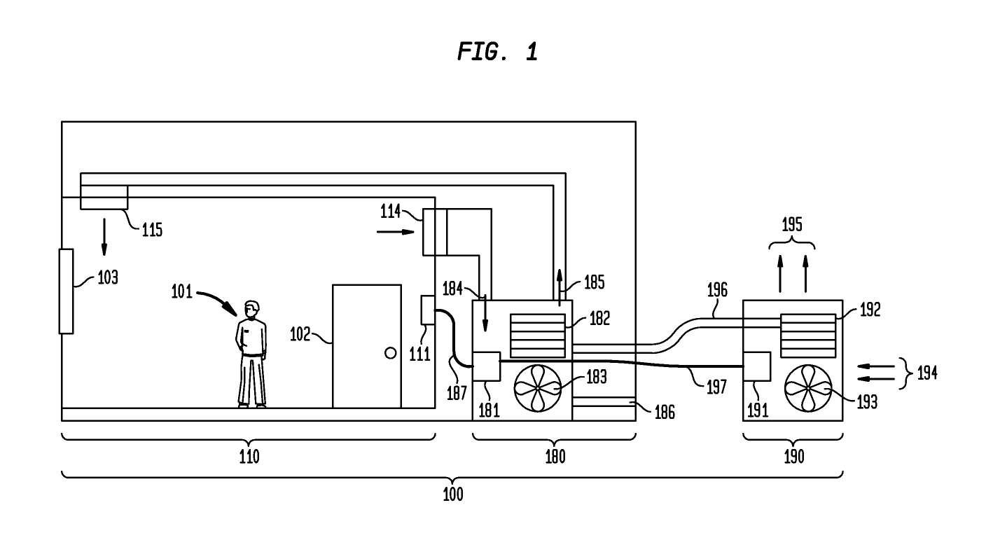

FIG. 1 shows a side view diagram of an example common environmental system in a building site 100. As shown in FIG. 1, building site 100 includes an internal room 110, an internal equipment 180, and an external equipment 190. Internal equipment 180 and external equipment 190 may each separately include environmental control equipment (ECE), or may include ECE in combination. Examples of ECE a heater/furnace, an air conditioner, a heat pump (which may be capable of both heating and cooling), and further types of ECE. Internal equipment 180 and external equipment 190 may each include one or more types of ECE. An example implementation of external equipment 190 may include a control circuit 191, a heat exchanger 192, a fan 193, an air intake 194, and an air output 195. Control circuit 191 accepts rudimentary demand instructions such as heat mode, cool mode, and at least on and off. In more complex implementations of external units 190, control circuit 191 may accept multiple levels of demand between just on and off, also known as variable rate equipment. One function of control circuit 191 may be to prevent rapid changing controls to the other equipment so as to prevent immediate failure or over wear leading to short term failure. Control circuit 191 is connected to internal equipment 180 via a connection 197. A heat exchanger 192 radiatively collects heat from or dumps heat into external air 194 with respect to the material (gas or liquid) in a mechanical connection 196 to internal equipment 180. This is amplified substantially by forcing outside air 194 through the use of a fan 193 which forces air through heat exchanger 192 and back to external air 195.

Internal equipment 180 of FIG. 1 contains a control circuit 181 which sends control information to external equipment controller 191 via a connection 197. In a simple embodiment, connection 197 may comprise one or more wires with on and off control signals only. In an embodiment, connection 197 may include messaging style communication enabling thousands of commands and status with feedback, and potential external conditions such as temperature, back to control circuit 181 through connection 197 or a different connection, but with a data communications protocol. Control circuit 181 also connects to at least one zone sensor module 111 through an additional interface 187. In some embodiments, interface 187 may include one or more wires or other simple conductors facilitating one sensor and minimal user feedback, such as on and off. In another embodiment, interface 187 may include a more complex data and networking model affording numerous (e.g., thousands) of types of control and status messages between sensor module 111 and control circuit 181. In yet another embodiment, interface 187 may be a part of a network of multiple sensors 111 in multiple zones 110, with connection to multiple control circuits 181 in a building 100 containing multiple zones 110, for example. Persons skilled in the relevant art(s) would recognize an advantage of such a multiple zone networked environmental control system for the installation of a new control system through one point only for the control of all such zones in a particular building 100. Such a configuration may be standardized, centralized, and with minimal time for installation thus saving many labor hours and associated cost for installation, whether initial or retrofit.

Internal equipment 180 also contains a heat exchanger 182 which transfers heat into or out of the material of connection 196 to the external equipment. Internal equipment 180 also has a fan 183 for amplifying the heat transfer process into and out from the air in room 110 via air intake vent 114 and attached to port 184, and air outflow from port 185 back into room 110 ducted vent 115. In an embodiment, the air path between 114 and 184 may be referred to as a plenum, which is a general air path not necessarily connected specifically by a confined duct, and which is frequently the case in larger commercial properties. It is noted that internal equipment 180 may optionally have an air path 186 to an exterior environment to the building in order to supply ‘fresh’ air (also referred to as outside air). In some cases, air path 186 may be directly attached to ducting of port 184 via an air switching device called a damper. These systems are capable of bringing in exterior, fresh air, whether or not it is otherwise conditioned, to address several environmental factors, for example, carbon dioxide, which is not addressed in the otherwise closed loop systems.

Room 110 optionally includes humans 101 (e.g., none, one, two, etc. human subjects). Room 110 includes a sensor module 111 (e.g., wall mounted, ceiling mounted, floor mounted, etc.) that is capable of the detection of human(s) 101. A doorway 102 to room 110 may be a small opening with a hinged door for controlled access, of an opening in a wall that separates multiple rooms 110 without any physical door gating access into or out from room 110, or may be other type of doorway. In the depicted embodiment, room 110 optionally has a wall adjacent to the external environment with a window 103. In this embodiment, the external wall and window 103 may provide room 110 with radiant heating with sunlight, and also thermal gain and loss from natural thermal transfer between room 110 and the external environment.

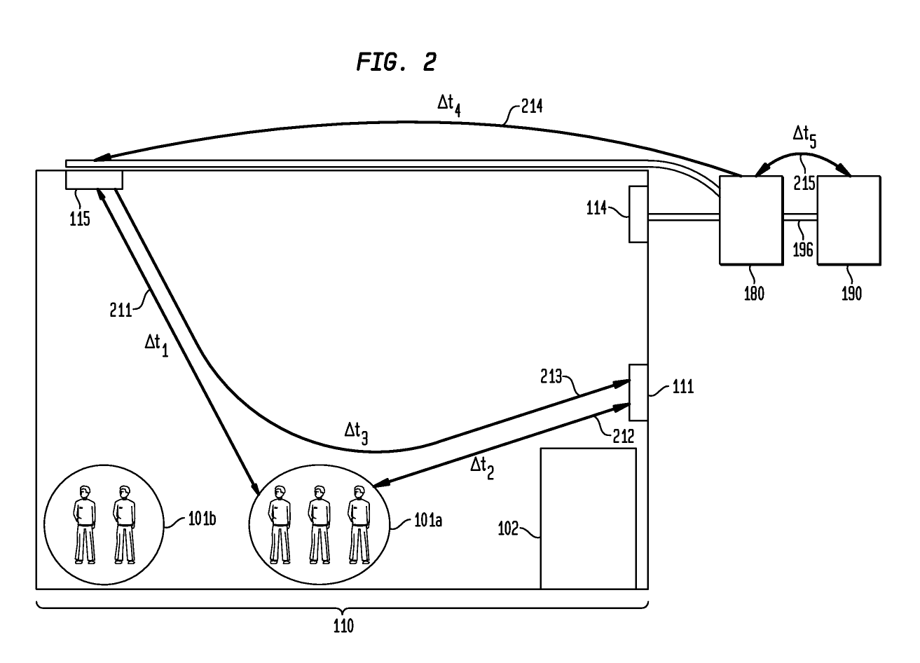

FIG. 2 shows a view of room 110 of FIG. 1. In FIG. 2, room 110 includes some additional details and airflow paths, including several heat transfer pathways and some equipment with some thermal mass to consider when designing a specific heat transfer system. In FIG. 2, an air pathway 211 is present between human subjects 101a and air pathway duct 115, an air pathway 212 is present between human subjects 101a and sensor module 111, and an air pathway 213 is present between duct 115 and sensor module 111 (although air pathway 213 is shown as curved in FIG. 2, air pathway 213 may have other shapes, including being straight). When environmental conditioning is performed, the effect is, in most cases, not recognized immediately by human 101a or by sensor module 111. Conditioned air exiting duct 115 via pathway 211 to human subjects 101a takes a delay time ΔT1. Similarly, and discretely different as a separate time delay, conditioned air exhaust from duct 115 via pathway 213 to sensor module 111 takes a time delay ΔT3. Furthermore, flow between human subjects 101a and sensor module 111 via pathway 212 has a delay time of ΔT2. Exterior to room 110, there are additional delays encountered within and between internal equipment 180 and external equipment 190. Each piece of equipment has inherent thermal mass, and therefore is not instantaneous in heat transfer. In some cases, larger industrial units may take several, even tens of minutes for an efficient thermal transfer to be realized. Delays within internal equipment 180 and between room 110 are depicted on a pathway 214, with a collective delay of ΔT4. Similarly, delays within external equipment 190 and between internal equipment 180 are depicted on a pathway 215, with a collective delay of ΔT5.

For purposes of explanation, a total environmental conditioning delay from the point of entry to room 110, a corresponding environmental impact of a human subject 101a entering into a room 110, and the effects of the conditioned air, through detection and equipment control, air pathway delays, etc., to be then experienced back at the point of human subjects 101a may be characterized as:

ΔT2+ΔT5+ΔT4+ΔT1=ΔTh Equation 1

As one skilled in the relevant art would recognize, the total delay ΔTh experienced by human subjects 101a can be several minutes, if not a substantial fraction of an hour. Current environmental control systems do not compensate for the effects of this total latency. In an embodiment, the above delays of ΔTh are taken into account to provide a more rapid and controlled environment surrounding human subjects 101a.

Another deficiency in the current design of environmental control systems is described as follows. In FIG. 2, pathway 213, having a delay of ΔT3, does not appear in the calculation above. This pathway is in the direct system feedback between conditioned air output from duct 115 and sensor module 111. Even without the impact of human subjects 101a, this time delay between the introduction of conditioned air, and the sensor recognition of a change of condition provides an unwanted delay. For instance, and by example only, a sensor module 111 may sense a high temperature environment, internal and external equipment 180 and 190 responds to reduce the temperature of the environment, and there is a delay ΔTs from the response for a period of time characterized by the following equation:

ΔT5+ΔT4+ΔT3=ΔTs Equation 2

By the time sensor module 111 has sensed the temperature target, the environment elsewhere in the room has fallen below the target temperature. To further complicate this under-run of temperature, equipment 180 and 190 typically continues a gradual decline of cooling while in a heat transfer shutdown mode previously referred to as a feature of control unit 191 and 181. The effect upon sensor module 111 can be viewed as a cyclical under-run and over-run, which directly corresponds to the thermal transfer rate of the system (BTU/s) with respect to the time delay ΔTs. While the length of air pathway 211 is typically not as great as the length of air pathway 213, and hence the time ΔT1 is not as great as ΔT3, the net effect is that the over-run and under-run in temperature as observed by a human subject 101a is very similar in scale to that observed at sensor module 111 however, shifted slightly in the time reference, approximately ΔT3-ΔT1. Whether or not the time is shifted, the resultant cyclical under-run and over-run of a target temperature is undesirable by human subjects 101a.

The above example is described utilizing a most common environmental factor, temperature. Persons skilled in the relevant art(s) would recognize that the same effects correspond to control of most other environmental factors, such as humidity, carbon dioxide, etc. The application of one, many, or all of the environmental factors may be present in embodiments and does not depart from the spirit and scope of the present invention.

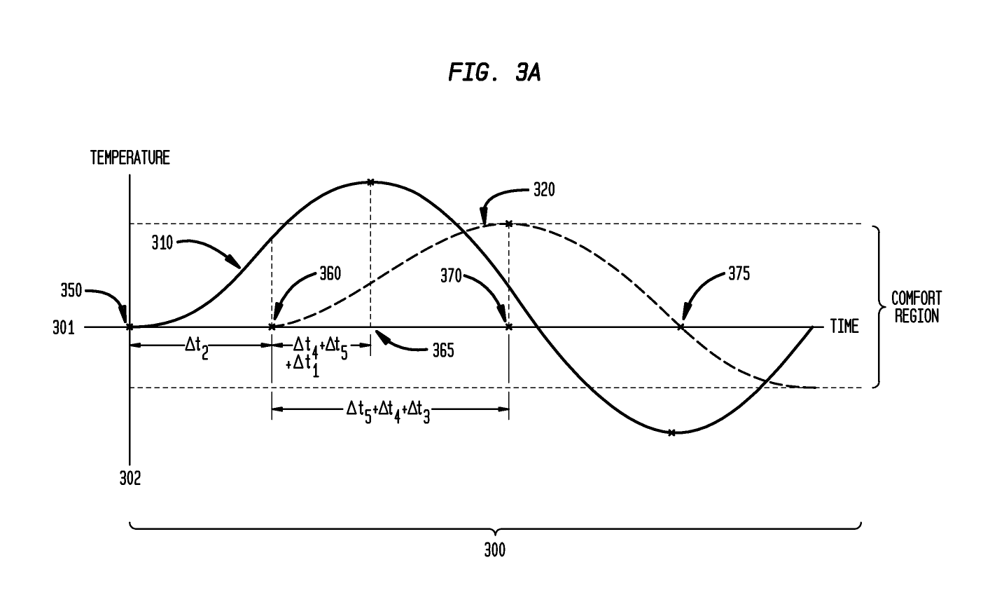

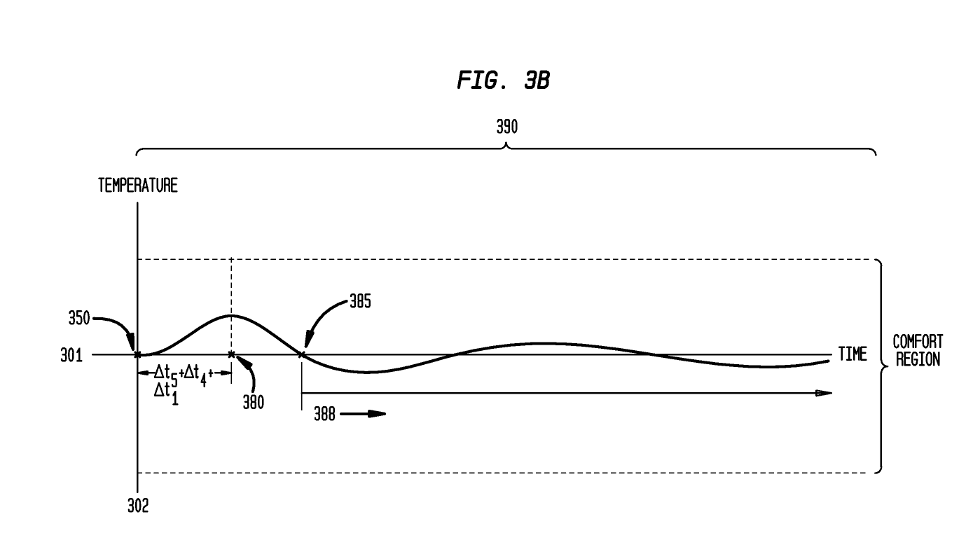

FIG. 3A depicts a time graph or chart 300 of cyclical temperature under-runs and over-runs due to the environment described with respect to FIGS. 1 and 2. Chart 300 has a time scale 301 depicted horizontally (x axis), and a temperature scale 302 depicted vertically (y axis). An environment temperature in immediate proximity to human subjects 101a in FIG. 2 is depicted in FIG. 3A on line 310, starting at time of entry to room 110 of FIG. 1 and labeled time point 350. The temperature increases around and as a result of human subjects 101a as depicted by line 310, but as a result of time delay ΔT2, the temperature increase is not sensed by sensor 111 until time point 360. The temperature detected by sensor 111 is depicted by line 320 and on the same time scale. Line 310 and 320 then illustrate temperatures at 2 spatial locations relative to the same time. At time point 360, a traditional environmental control system will indicate a demand for cooling. Conditioned air (cooling), however, as a result of combined time delays ΔT5+ΔT4 will not enter the room until a later time. Human subjects 101a may perceive a change in temperature after an additional time delay ΔT1 at a time point 365. At time point 365, the temperature around human subjects 101a may be at a maximum, and may be higher than a desired comfort temperature. From the perspective of sensor module 111, the conditioned air may not be sensed until time point 370 after a combined time delay of ΔT5+ΔT4+ΔT3. The conditioned air lowers the temperature around sensor module 111 to a target temperature at time point 375. However, from the perspective of human subjects, 101a, at time point 375 the temperature has been over conditioned, past the desired target temperature of human subjects 101a, and also possibly below a desired comfort level. Chart 300 then illustrates the latency inherent in the design of traditional environmental control systems, and the effect of cyclical under and overruns of the environment as perceived by human subjects 101a as opposed to sensor module 111.

In an embodiment, one or more environmental factors are directly detected, or indirectly predicted (through the direct detection of the human subjects) in the immediate proximity to human subjects 101. Furthermore, embodiments may compensate for as many of time delays ΔT1, ΔT2, ΔT3, ΔT4, ΔT5 in as many of the environmental factors as is practical given the target cost and target complexity of an implementation. In an embodiment, for example, a system can immediately sense the presence of human subjects 101a, and immediately call for cooling, for example, to an amount of cooling necessary to maintain a target temperature taking into consideration the additional heating effect of the presence of specific human subjects 101a. In this embodiment, the initial impact of ΔT2 is completely eliminated, and the longer term effect of delays ΔT5+ΔT4+ΔT3 can be predicted and compensated.

For example, FIG. 3B shows a chart 390 of temperature in a room that is environmentally controlled according to embodiments. Chart 390 illustrates the temperature in the immediate vicinity of human subjects 101a. Time point 350 indicates entry of the human subjects into room 110. These human subjects are immediately detected through sensor 111, and conditioning equipment 180 and 190 are immediately activated. There is a delay ΔT5+ΔT4+ΔT1, shown as time point 380, whose time and temperature impact are calculated with close approximation from system responses of prior system operations. Furthermore, these calculations can be ‘learned’ from only the operational system responses of the installed system, or these calculations may be remotely computed through behaviors of many systems through data channels such as the Internet. Chart 390 of FIG. 3B also illustrates that algorithms can approximate the amount of temperature overrun experienced by human subjects 101 and provide an increased call for cooling during an initial time period 385 (an initial ‘shot’ for predicted catch-up) followed by the remainder of the operational period depicted by time period 388, providing the amount of cooling necessary to address the relatively constant heat load introduced by human subjects 101a upon room 110. As depicted in chart 390, there may be some expected fluctuation of the temperature as is necessary to accommodate other influences on the environmental factors that cannot be normalized in the prediction algorithms, but are sensed by sensor 111 with its inherent latencies.

The preceding is a simple example addressing only one environmental factor (temperature, such as heat). In alternative embodiments other environmental factors, such as CO2, will provide similar results in their respective environmental factors. In complex embodiments, multiple environmental factors may simultaneously be addressed.

For instance, similar charts to charts 300 and 390 may be generated for each and every environmental factor of interest, such as humidity, carbon dioxide, etc, but are not depicted for illustrative complexity reasons. In embodiments, a system may take any one, a combination, or all of the environmental factors into account in sensing and/or logic and equipment control.

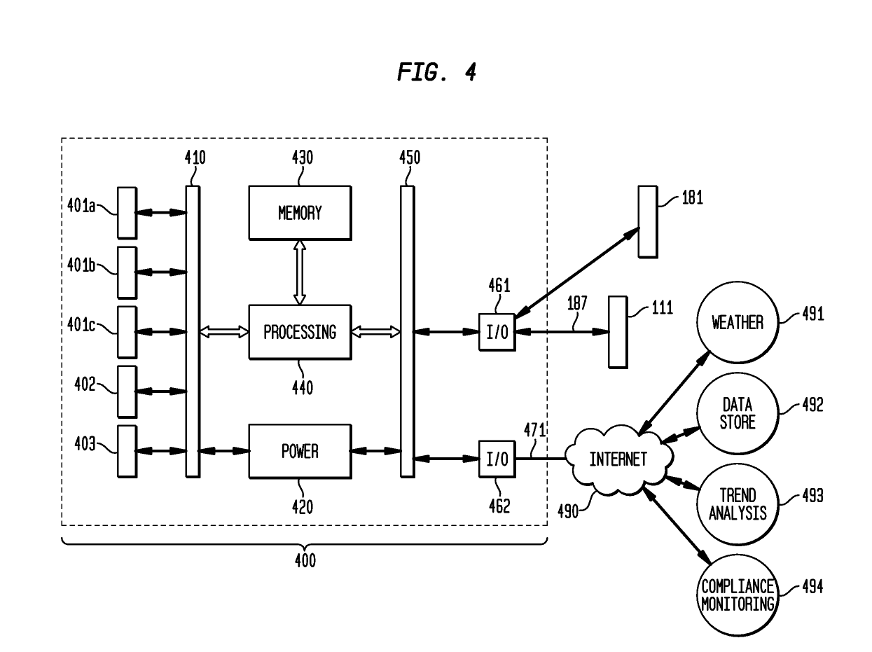

FIG. 4 illustrates an environmental control system (ECS) 400, according to an example embodiment. For instance, ECS 400 may be applied within the structure of FIG. 1 to supplement or replace sensor module 111. As shown in FIG. 4, ECS 400 includes sensor components 401a-401c, 402, and 403, a communication bus 410, a power module 420, a memory 430, a processing unit 440, a communication bus 450, a first I/O (input/output) communication module 461, and a second I/O communication module 462. These components of ECS 400 may individually be located within a single housing, located in individual housings, or any combination thereof. Persons skilled in the relevant art(s) will recognize that these components may be co-located or separated in one or more discrete housings for a variety of reasons that may include cost, form factor, or proximity to other interfaced equipment or environments. Furthermore, as shown in FIG. 4, ECS 400 interfaces with one or both of environmental conditioning equipment 111 and 181 (of FIG. 1), and interfaces with one or more of services 491, 492, 493, and 494 through a network 490 (e.g., a local area network (LAN), wide area network (WAN), or combination of networks, such as the Internet). FIG. 4 is described as follows.

As mentioned above, ECS 400 includes sensor components 401a-401c, 402, and 403. These sensor components interface with processing unit 440 through communication bus 410. Communication bus 410 may be an internal or external bus, and may be parallel or serial in nature. Power module 420 supplies power throughout ECS 400 but does not preclude one or more further individual power supplies within remotely located components of ECS 400. Processing unit 440 also interfaces with memory 430 and communication bus 450. Input and output controls (e.g., control signals) and communications with environmental conditioning equipment 111 and/or 181 may occur from processing unit 440, through communication bus 450, and first I/O communication module 461. Another class of interface to network resources (through a variety of potential carriers and equipment such as WiFi, or 3G cellular data services or similar) may established from processing unit 440, through communication bus 450 and second I/O communication module 462, and through network 490 to services 491, 492, 493, 494, etc.

The communication bus architecture of FIG. 4 is depicted for illustrative purposes. Persons skilled in the relevant art(s) would easily realize that all communications to and from processing unit 440 can be through one or more communication busses. A restructuring of communication busses and attached devices that differs from the depiction of FIG. 4 is within the spirit and scope of the present invention. Furthermore, multiple modules may be optionally co-located into one silicon package, such as the integration of processing unit 440, memory 430, and communication busses 410 and 450. Industry standard implementations of System On a Chip (SOC) devices frequently combine these components and many more into a single silicon package. Co-locating these components within a single silicon package is within the spirit and scope of the present invention.

FIG. 4 depicts a plurality of optionally locally attached and/or accessible network attached services. An optional network attached service is a current weather service 491. By way of example only, service 491 may be a current weather service, which may indicate a current exterior environment to include, but not limited to temperature, humidity, exterior air quality (such as ground level ozone), radiative solar thermal energy (how hot the sun's rays are), and any potential cloud cover factors. A service such as service 491 enables external environmental conditions in one, many, or all of the environmental factors, to be applied to processing unit 440. Processing unit 440 may be configured to calculate and predict an impact upon room 110 such as, for example, known exterior humidity and the potential dehumidification necessary for the introduction of the exterior air into room 110. In such an embodiment, processing unit 440 may be referred to as an environmental impact processor configured to determine an impact of environmental factors on room 110, to determine an impact of one or more humans in room 110 on the environmental factors and/or on room 110, and/or to determine further environmental impact information. While a local sensor implementation does not depart from the spirit and scope of the present invention, the common source available to hundreds or thousands of buildings affords the same functional benefit for a reduced cost of implementation and maintenance.

Another optional network attached service is a data store service 492. Data store service 492 may provide data storage that may be more reliable, more cost efficient, larger, and remotely managed, maintained, and secure that may be available for the same cost and/or convenience at local environment 100 in FIG. 1. The location of data store service 492 may be local to ECS 400 (without the need for network connectivity) or remote via network 490. While current large commercial environmental control systems may be able to justify an additional cost of a local data store and its maintenance, it may be much more cost efficient, given a building's typical connection to the Internet, to centrally locate such a service. A centrally located data warehouse can then apply one or more algorithms to groups of data stored by data store service 492, which may be grouped by property owner, environmental control contractor, environmental equipment provider, compliance and other regulators, and even third party data analysis service providers. In an embodiment, data store service 492 may be a professionally managed solution for data warehousing, which may provide a more secure and available service for less cost than a local solution, thereby providing similar features and functions to a much larger consumer base.

Another optional network attached service is analysis service 493. With a reliable data warehouse, data analysis algorithms, trend analysis, and cross reference to a multitude of other data can be performed by service 493. With an input from analysis of the data warehouse generated by service 493 as a feedback, and/or fine tuning of the algorithms of environmental control, a more accurate control of each and every environmental factor may be provided, resulting in a better conditioned environment for human subjects 101, and a more efficient use of energy. Completely new lines of business of providing services or applications for data analysis, similar to downloadable applications for smart phones, may be provided by leveraging results of analysis back into the algorithms of operation in ECS 400. For instance, an Internet service of trending analysis can determine operational effectiveness of environmental systems over time, given interior and exterior environments, and alert the property owner, the property environmental service organization, or the operational management of the property of FIG. 1 as to reduced efficiency, the impact to equipment life expectancy, reduced service intervals, and potentially a loss of governmental efficiency credits, awards, etc to the specific property. Another example of a provided service is a periodic report that may be generated, that can be textual or graphical, and showing an analysis of the data in the data warehouse. Furthermore, with a centralized data warehouse, comparative analysis against similar equipment manufacturers, similar exterior or interior (or both) environmental conditions, or a similar size of room 110 and/or number of human subjects 101 may be performed.

A compliance monitoring service 494 is another optional service that may be provided, in embodiments. Compliance monitoring performed by service 494 may include reviewing of configuration, energy usage, equipment efficiencies and trending, and/or system performance through a variety of numbers of human subjects 101 in any or all of rooms 110 within location 100. Monitoring for compliance to standards may afford the owners and/or management of the location 100 with credits for efficiency. The operators of location 100 may also be alerted to system degradation in one or multiple rooms 110 and/or equipment 180 or 190 or other equipment implemented for the control of the many possible environmental factors.

Services 491, 492, 493, and 494 are provided as example services, and are optionally present. Additionally or alternatively, further services not mentioned herein may be used, as would be apparent to persons skilled in the relevant art(s).

By way of example, sensor components 401a, 401b, 104c, 402, and 403 are configured to sense environmental factors and/or human presence in room 110 of FIG. 1, and also optional exterior environmental factors that may be closely proximate to air pathway 186 of the FIG. 1. Fewer or additional numbers of sensors may be present, in embodiments.

Sensor components 401a-401c are intended to illustrate environmental factor sensors for a single room 110. Sensors 401a-401c may be located within one housing, in separate housings, any combination thereof, and/or may be remotely located in a master/slave arrangement without departing from the spirit and scope of the present invention. By way of example, a sensor component 401a may be configured to detect a presence and quantity/number of human subjects 101 within room 100 of FIG. 1. In an embodiment of sensor 401a, the presence of human subjects 101 may also be augmented to also sense the size of and/or thermal signature of human subjects 101 either each individually or as a group collectively. A closer approximation of the impact of one or more larger and/or hotter human subjects 101 (as compared to smaller/cooler humans) may provide a more accurate input to the prediction algorithms and the environmental controls. For example, 50 large adult humans may be expected to impact their environment (in heat, humidity, and CO2) more than a same population of small children of the same level of activity. A sensor component 401b may detect a current temperature, and a sensor component 401c may detect a carbon dioxide level present in a room 100 of FIG. 1. Additional sensor components 402, and 403 are depicted with the illustrative intent on showing a component level system with multiple sensor components in multiple rooms 110 (e.g., rooms a, b, c, etc.) where all communicate with a remote and centralized processing unit 440. Additionally, other sensor components (e.g., sensor components) 401d-401f not shown in FIG. 4 may be present that may detect other environmental factors such as radiative heating or cooling sources and amounts, humidity, oxygen levels, presence of airborne viruses and bacteria, brightness of sunlight, ozone levels, airborne particulate levels (dust), air opaqueness (smoke), and other environmental factors that may be of interest in providing a well conditioned, high air quality space for human presence. Use of one, many, or all in any combination in one or many rooms of location 100 of FIG. 1 does not depart from the spirit and scope of the present invention.

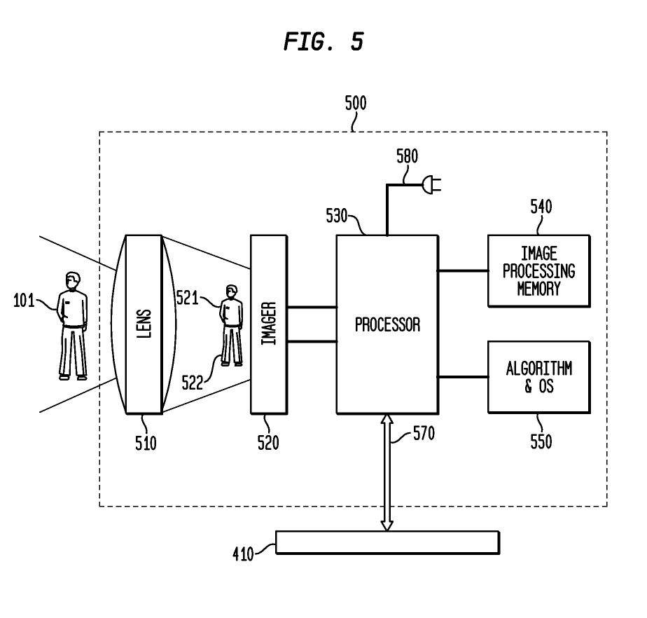

FIG. 5 depicts a block diagram of a sensor 500 that is an example of sensor 401a of FIG. 4, according to an embodiment. In an embodiment, sensor 500 of human subjects 101 may be an optical sensor. As shown in FIG. 5, an optical version of sensor 500 may include a lens 510, an optical imager 520, a processor 530, memory 540 for image analysis, an operating system (OS) and algorithm 550 (e.g., stored in memory 540 or other storage), a power management and conditioning module 580 (e.g., a power supply, a connector for interfacing with a power source, etc.), and a communication bus 570 for connection to an environmental control system (e.g., by interfacing with communication bus 410 of ECS 400 externally or internally to sensor 500). Sensor 500 is described as follows.

A first embodiment of a sensor 401a may be a sensor 500 positioned over the top of doorway 102 of room 110 depicted in FIG. 1. Lens 510 may be configured as appropriate to focus an image of human subjects passing through doorway 102 onto imager 520. For instance, lens 510 (e.g., by virtue of the placement of sensor 500) may image a full doorway width of doorway 102 and little if any of room 110. Imager 520 may capture the image (represented in FIG. 5 as captured image 521), and provide the captured image to processor 530. Processor 530 may be configured to execute instructions for algorithm 550 that are contained in storage. Processor 530 may also utilize another memory and/or image processing memory 540 for the storage of the captured image. Memory 540 may also store a previous image or images to be accessed by processor 530 executing instructions of algorithm 550 for the calculation of a) motion, b) direction of motion, c) rate of motion, and/or d) object classification. In an embodiment, by executing algorithm 550, which includes image processing logic (e.g., human recognition logic, motion recognition logic, etc.), processor 530 may determine if a person in captured image 521 within the full image has moved in comparison with a previously captured image 522. Furthermore, by executing algorithm 550, processor 530 may also determine the direction of this movement by analysis of captured image 521 and previously captured image 522. Still further, if images 521 and 522 are collected periodically, or with a known timing, a rate of movement of a person in image 521 can also be calculated by algorithm 550. Persons skilled in the relevant art(s) would recognize an advantage of a robust algorithm for the detection of an image movement may rely upon an image resolution, a rate of image periodicity, and a potential for an improvement of robustness upon the number of images processed, and hence the amount of memory 540. Furthermore, algorithm 550 may be configured to reject the processing of certain areas of image 521 in order to offer the benefit of processing only the desired areas of image 521 as a more convenient method to that of optically masking undesired portions of images with a lens 510 so as to preclude an incorrect analysis as to movement in a direction of which is not entering or exiting room 110. Commercially available video security cameras may include lens 510 and imager 520. Products referred to as web cameras may provide additional features of sensor 500. However, a key distinction from commercially available cameras is algorithm 550 for processing of the images. In a first embodiment, algorithm 550 performs image analysis/calculations to recognize a human subject and any movement of the human subject based on an analysis of images 521 and 522 (and optionally further captured images). When processor 530 has detected the human presence, a communication to an environmental control system may occur on communication bus 570 as to the human presence related to a room entry or exit event.

Due to differing requirements driven by cost, complexity, and even individual security concerns, embodiments of communication bus 570 may also vary widely. For instance, an embodiment of communication bus 570 may be a simple pair of wires with an encoding of a voltage pulse V1 to indicate a human subject 101 entering a room 110, or an encoding of a voltage pulse V2 to indicate a human subject 101 leaving a room 110. A similar embodiment may comprise two pairs of wires, one to indicate a human subject 101 entering room 110, and the second pair of wires to indicate a human subject 101 leaving room 110.

However, in another embodiment of communication bus 570, a more sophisticated network communication may be used, such as an Ethernet communication link, and/or an Internet protocol (IP) network, wired or wireless. Persons skilled in the relevant art(s) would realize, based on the teachings herein, that additional features may be provided, such as the ability to remotely program algorithm 550 (and OS) through communication bus 570. Another benefit may be to generate additional information about human subjects 101, such as the rate of movement, a size of human subject 101, a total count of human subjects 101 in a room 110 (in additional or alternatively to the increment/decrement mentioned above). These additional features are by way of example only, and are not meant to be limiting. There are many features known to persons skilled in the relevant art(s) of image processing and comparison that may be desired for processor 530 to be able to communicate to an environmental control system through communication bus 570. Any type of communication of information from sensor 500 to an environmental control system may be used, in embodiments.

An alternate embodiment of sensor 500 may collectively image an entire room 110, as opposed to just doorway 102. By way of example only, a room 110 may not have a confined doorway 102, but a more open passageway that may be much more difficult to control and monitor access to by human subjects 101. In such an alternate embodiment, lens 510 may be constructed as to allow the image of a full room 110 to be focused onto imager 520. In addition, image algorithm 550 may be able to recognize many images of human subjects 101 within a single image. Algorithm 550 may enable processor 530 to compute position information for a multitude of human subjects 101, and may track the movement of each of the human subjects 101. Subsequently, an image processing memory 540 may be increased in capacity, and imager 520 may have an increased resolution in order to capture the multitude of human subjects 101 with enough resolution in each of the subset portions of a captured image 521 for algorithm 550 to detect each individual human subject from within captured image 521. Persons skilled in the relevant art(s) would recognize that such an alternate embodiment may have a higher resolution imager but may use a less frequent periodicity of image capturing. For instance, the requirement of an environmental system may be to take an inventory of human subjects 101 every minute or more. Sensor 500 in such an alternate embodiment may capture a high resolution image every minute, processing each captured image within a minute to arrive at the result of an indication of how many human subjects 101 are present at that minute interval within room 110. In comparison, the event based embodiment of sensor 500 described above, which images just doorway 102, may have a greater frequency of capturing images so that some entry and/or exit events for human subjects 101 are not missed, although a lower resolution of capture images may be used. Algorithm 550 of the event based embodiment may derive numbers, sizes, and/or further information for human subjects 101 from the knowledge of entry and exit events. Alternatively, algorithm 550 of the alternate embodiment (collective imaging) may be capable of determining how many human subjects 101 are in a room 110, but may derive from that a total number of persons that have entered/exited, or in other manner.

In an embodiment, sensor 500 may be configured to capture and analyze optical information in thermal frequencies. Persons skilled in the relevant art(s) would realize that implementations in low or reduced visible light environments may be used to prevent inaccuracies in recognizing human subjects 101 in images without extra illumination. For these environments, sensor 500 may collect and analyze images in the thermal optical frequencies. Human subjects 101 may emit detectable thermal information without any necessity for added environmental illumination (even in the near infrared frequencies). An example of a common application is the previously mentioned security ‘occupancy’ sensor. The sensed information is thermal in nature and does not require additional illumination in any frequencies. The algorithms of the security ‘occupancy’ sensor, however, may only currently detect movement of any kind and in any direction. Similar to the multiple, optical (visible light) sensors described above, embodiments of thermal frequency based sensors can either be event based (entry and exit event based output) or whole room collective thermal image analysis. An advantage to thermal imaging is a system that does not require an optically illuminated room. However, a more subtle advantage to thermal imaging and analysis is the ability to determine a thermal mass of a human subject(s) 101 either individually or collectively.

In an embodiment, algorithm 550 may be configured to analyze a thermal image 521 retained in memory 540. A thermal mass analysis is analogous to a general brightness determination of a standard, optical image. Each pixel of a standard image has a brightness, or intensity level. The average brightness level across all pixels of interest, for example all pixels of a human subjects 101 which excludes all other pixels, can determine a visible brightness of human subjects 101. An overall thermal mass algorithm of 550 performs the equivalent procedure, however, executed on the pixels of a thermal image. Those pixels indicate the intensity, which is the amount of heat emitted, of that small area captured by the pixels of human subjects 101. Collectively, the average thermal mass of human subjects 101 can be assessed by evaluating, and for example averaging, all of the thermal pixels associated with the image 521 of human subjects 101 in memory 540.

Thermal mass may be used in prediction algorithms to assess the specific impact of human subjects 101 into the environment of room 110. For example, a large thermal mass may introduce more thermal input into room 110, which may require more cooling in order to compensate. A room 110 full of large, hot human subjects 101 may certainly require much more conditioning than an equivalent number of human subjects 101 that are much cooler and/or smaller in thermal size. Furthermore, yet another advantage to thermal imaging and analysis over visible light is an ability to assess the human subjects' currently desired environmental conditions, herein referred to as environmental factor(s) requirement. By way of example only, an exercise room with many human subjects may initially, prior to exercise, feel more comfortable in a warmer environment. In an embodiment, sensor 500 may analyze thermal imaging of the human subjects to have a less hot (lower pixel intensity) thermal signature and may algorithmically implement a need for a warmer environment for room 110, for example, 74 degrees (F.) as a thermal environmental factor requirement for the human subjects determined to be less active. As the human subjects start to exercise, and over some time period they become individually (and collectively) a larger—or hotter (higher pixel intensity) thermal signature, an embodiment may be configured to determine that both the heat input by the human subjects has increased (while the actual number of humans have not) but also that the desired environment surrounding the human subjects may be cooler for the same comfort level, in this case, for example, the thermal environmental factor requirement of 70 degrees for the human subjects determined to be more active by algorithm 550 of sensor 500 determining a higher overall thermal mass. The environmental algorithms of sensor 500 may lower the desired target temperature while also compensating for the increased heat input of the human subjects. An advantage of such an embodiment of sensor 500 over conventional techniques is that the desired environment, or environmental factor(s) requirement, is assessed automatically as opposed to requiring explicit human input.

In another embodiment of sensor 500, algorithm 550 may predict the augmented levels of other environmental factors, such as CO2, oxygen, and humidity as would be apparent to persons skilled in the relevant art(s), when considering an impact of a larger thermal signature of human subjects 101, such as during exercise as compared with the same population with smaller thermal signature, such as before exercise and/or at rest. In an alternate embodiment, sensor 500 may analyze the thermal contrast of the human subjects, for example, concluding that there are specific areas of a human subject, such as exposed face and arms that are much higher intensity (hotter) than the average intensity of all of the pixels of the human subject. Alternatively, those areas of the human subject may be determined to exceed a pre-defined threshold of intensity (hot threshold). In still another embodiment of sensor 500, algorithm 550 may analyze multiple images 521, 522 in memory 540 for a rate of motion (how many pixels the image has moved in 521 from previous 522 with a known time period) for the portion of the image determined to be human subject(s). This rate of motion can occur and be determined utilizing a standard or thermal image embodiment of sensor 500. Processor 530 executing algorithm 550 may determine that a collective rate of motion of all human subjects (for example an average of each of the individual human subjects) in the image memory 540 exceeds a defined limit associated with ‘activity’.

Persons skilled in the art of the biosciences will realize that other environmental factors, such as an increase in humidity, an increase in CO2 production (and corresponding decrease in Oxygen levels), and/or potentially higher emission of body odors can be associated with increased human bodily function through increased activity levels or other conditions common to humans (such as fever). The environment will be altered and will require conditioning to the environment to enact adjustment of each of the effected environmental factors. Furthermore, each of the environmental factors may have an altered environmental factor requirement that can be assessed through sensor 500 in an automated fashion similar to the preceding example pertaining to the thermal environmental factor requirement. By way of example, a standard optical or a more precise thermal analysis in sensor 500 of active human subjects may lead to a conclusion that, in addition to a need for a cooler room (thermal environmental factor requirement), a lower humidity may be desired (humidity environmental factor requirement), and more ventilation of external air may be desired (CO2, Oxygen, and odor environmental factors requirement).

Persons skilled in the relevant art(s) of environmental control design would realize an added benefit from the identification of an individual. By way of example only, an environmental system design that has knowledge of a specific human subject 101a that may have a different comfort level requirement (for example, cooler) than another specific human subject 101b may have great benefit from an automation aspect from the recognition of human subjects 101a and 101b within a room 110. More specifically, if a human subject 101a prefers a room temperature of 72 degrees, and is detected within room 110 by a sensor, an environmental control system can set its preference to this individual at 72 degrees. However, if the sensor of the same environmental system can also detect the presence of human subject 101b with a temperature preference of 69 degrees, the environmental control system may be able to facilitate a cooler environment for that individual. In yet another embodiment of sensor 500, a lens 510 can focus an image 521 of a human subject 101 onto imager 520. An algorithm 550 can compare a subset of image 521 against a stored image in image processing memory 540, processor 530 then recognizing, for example, a face of human subject 101. Conventional techniques may be used, such as facial recognition systems and algorithms that can implement such a feature for use by an environmental control system. A visual recognition element within sensor 500 may be used in an embodiment.

In still another embodiment of an image recognition system, 500, the environmental control system of a room 110 (e.g., a hotel room, or a meeting room whereby environmental control is not desired for transient maintenance staff such as maid services, or cleaning services, respectively) has an image recognition algorithm in algorithm 550 that compares a uniform insignia or other markings of a known maintenance uniform stored in image processing memory 540. Persons sensed/recognized by their uniform insignia or other markings may be taken into account with regard to an ECS (e.g., by raising or lowering environmental temperature based on their presence), or may be ignored by the ECS (e.g., because they are assumed to be transitory and/or for other reason). In alternate embodiments, these insignias may be specifically encoded with patterns of color (to include near infrared), a 1 or 2-D barcode (for standard optical evaluation), or potentially a thermally reflective pattern in the case of a thermal imaging sensor, which may be desired as being more discrete to public awareness. For instance, processor 530 may communicate a presence of a standard human subject 101a through communication bus 570, but may communicate the presence of a human subject 101d with a recognized pattern, uniform, and/or insignia information. Alternatively, algorithm 550 may be configured to ignore the presence of human subject 101d with a recognized pattern, uniform, and/or insignia by not communicating/determining any change in the number of human subjects that are present, and/or to not cause an impact on an environmental control system.

In an embodiment of an image recognition system embodiment for sensor 500, the environmental control of a room 110 (e.g., a residential house) may not be desired for pets. Alternatively, the environmental control system may have different ranges or targets for the environmental factors in a case where no humans are present but pets are present. An image recognition system that recognizes the presence of pets (and may recognize specific pets) may differentiate a pet from a human for a variety of reasons. Similar to the above embodiment where a hotel environmental control system differentiates between guest and maintenance staff, the residential system could differentiate between humans and pets, and may provide change to the environment conditions when a pet is detected, or may ignore the presence of a detected pet (by not changing the environmental conditions).

Note that in embodiments, persons/individuals may be identified by the use of an RF (e.g., radio frequency identification (RFID)) tag. In another embodiment, persons/individuals may be identified by association with an active personal communication device (cell phone, smart phone, etc) as many of these devices now carry unique identification means to associate preferences to a specific individual in a similar manner that is afforded by the use of an RFID tag/system.

As such, in embodiments, an ECS (e.g., ECS 400 of FIG. 4) is configured to control one or more environmental factors of a space (e.g., room 110 of FIG. 1), such as providing heat or cooling to the space, controlling humidity, controlling CO2 levels, etc., using environmental control equipment. The ECS includes one or more sensors (e.g., one or more of sensors 401a-401c, 402, 403, and 500) to sense environmental factors associated with the space, such as one or more of temperature/heat, humidity, CO2, odors, fragrances, radon, and/or other sensed environmental conditions such as light intensity and sound volume, and to process the information indicative of the sensed environmental factors to control the one or more environmental factors. Furthermore, the ECS may sense the presence of one or more humans, including a number of humans, a thermal mass of the humans that are present, a movement/activity of the humans, etc. The ECS may take into account the impact of the humans present on the environmental conditions of the space, such as additional heat and CO2, and may control the environmental control equipment accordingly. Furthermore, the ECS may increase, reduce, or otherwise change environmental controls provided to the space if the number of humans in the space changes. For instance, if all of the humans leave, the ECS may control the environmental control equipment into a lower power mode to account for the reduced need for environmental control. Still further, the ECS may receive information from one or more services (e.g., one or more of services 491, 492, 493, and/or 494, such as a weather service, etc.), and may increase, reduce, or otherwise change environmental controls provided to the space accordingly.

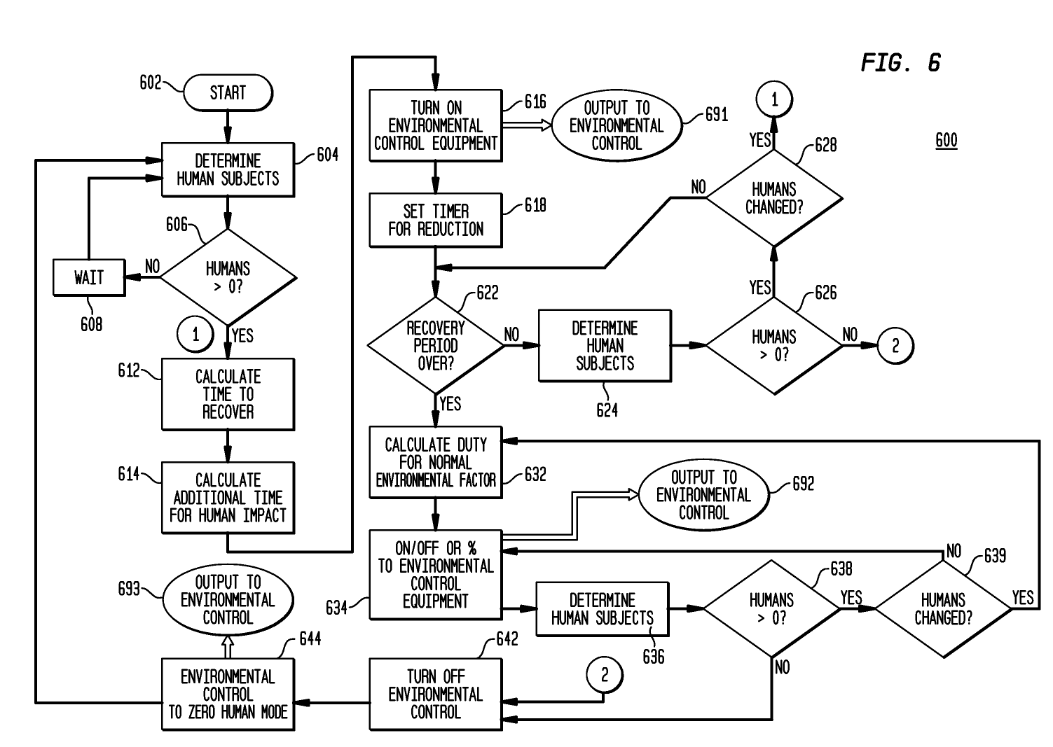

For instance, FIG. 6 shows a flowchart 600 providing a process for the control of a typical environmental factor (e.g., temperature), according to an example embodiment. For instance, in an embodiment, flowchart 600 may be performed by an ECS embodiment described herein, such as ECS 400 of FIG. 4. For example, one or more of sensors 401a-401c, 402, and 403 may be present to perform sensing functions of flowchart 600 and/or described below, including determining human subjects that are present (e.g., counting a number of human subjects, determining a thermal mass of human subjects, etc.), measuring heat/temperature (e.g., thermometers or other temperature measuring sensors), measuring humidity (e.g., barometers or other humidity measuring sensors), measuring levels of CO2, measuring time (e.g., using a clock, counter, or timer), etc. Furthermore, processing unit 440 (e.g., environmental impact processor) may perform calculations and/or determinations shown in flowchart 600 and/or described below, and may generate controls/control signals to control environmental control equipment as shown in flowchart 600 and/or described as follows. For instance, in an embodiment, processing unit 440 may execute program code configured to perform steps of flowchart 600 and/or operations described below. For purposes of illustration, flowchart 600 and the following description refers to a common environmental factor—heat. In an embodiment, one or more additional environmental factors may be handled in flowchart 600. Further structural and operational embodiments will be apparent to persons skilled in the relevant art(s) based on the following discussion regarding flowchart 600. It is noted that the steps of flowchart 600 may be performed in other orders than shown in FIG. 6 and described below, and not all of the steps of flowchart 600 need to be performed in all embodiments.

Flowchart 600 starts at start point 602. There may be one or more procedural steps optionally included in step 602, including but not limited to a procedure referred to as power on self test (POST). Many additional actions, such as configuration (as to what and how to control the attached environmental equipment and also discovery of attached systems and devices to a network) may occur during step 602. Such actions may be known to persons skilled in the relevant art(s). Operation proceeds from step 602 to step 604. In step 604, a number of humans that is/are present is determined (e.g., counted). For instance, one or more sensors described above may be used to determine human presence 101 in room 110 of FIG. 1. Human presence 101 is collectively represented as a count of human subjects. Alternatively, and in another embodiment, human presence 101 can be represented as a more precise quantitative impact to an environmental factor, for example, heat. In such an embodiment, human presence 101 can be determined as a BTU impact to the environment. A BTU impact to the environment is more quantitative in that larger and more active human subjects 101 may add more heat than smaller or less active human subjects 101 such as children. It is possible that multiple children may have the same environmental impact as one large adult human. Therefore, in an embodiment, an accurate calculation of the environmental impact of a population of human subjects 101 may deviate from the average impact of the original embodiment depicted in FIG. 6. In some implementations, a count of humans may be performed. In other implementations with more widely varied human subjects 101, it may be desirable to determine the BTU impact to the environment by the humans that are present, rather than just counting humans that are present, even if such an implementation may cost more. Either or both of a simple count of human subjects 101 or the more precise environmental impact of human subjects 101 may be used, in embodiments. For ease of illustration, flowchart 600 is shown utilizing a count of humans that are present. In addition to heat or BTUs as an environmental factor, additional factors, such as, but not limited to, moisture and CO2 may be additional environmental factors to account for, predict impact to, etc., similarly to the heat environmental factor, but for ease of illustration are not included in FIG. 6.

After step 604, operation proceeds to step 606. In step 606, whether any humans (e.g., more than zero) are present is determined. If the number of humans present is determined to be zero, operation proceeds to step 604, after an optional wait period 608. For example, control of the environmental factors within an expanded operation range may be optionally performed during wait period 608. From the teachings herein, persons skilled in the relevant art(s) of environmental control would realize that a system may allow a zero human presence condition to relax an environmental factor range to one that could be recovered reasonably quickly in the event of a determination of a human presence. By way of example only, a desired temperature of 75 degrees for humans/persons being present may lead to the room being maintained at a temperature of 80 degrees when no humans are present, which may correspond to a 15 minute recovery period with current environmental control equipment. A recovery period may be determined in part based upon the ability of the equipment (rate) to provide the necessary thermal transfer into or out of the room. In addition, the recovery period may also be affected by, for example, the sun's additional heat input incident upon room 110 of FIG. 1. As such, heat from the sun may be compensated for, in embodiments.

If a human presence is detected and quantified, operation proceeds to step 612, where a time to recover from the room's present condition (potentially in a multitude of environmental factors) is calculated. In one embodiment, a single environmental factor such as temperature may be considered in step 612. By way of example only, a thermal impact of environmental control equipment (at 100% duty cycle, or continuous operation) on a room may be 100,000 BTU per hour. At a present condition, room 110 may have (in the case of heating) 10,000 BTU as a prediction to reach a target temperature. In the simplest case, 10,000/100,000 hours ( 1/10th of an hour, or 6 minutes) may be required to adjust the thermal environment to a certain target. However, the immediate impact of human subjects 101 also should be factored into an embodiment. As such, in an embodiment, step 614 may be performed after step 612, where an additional time for human impact (e.g., the heat provided by the present human(s) is calculated. The calculated time for human impact may be included in a recovery time. Continuing the example above, for the time period of 6 minutes, human subjects 101 may add an additional 1600 BTU, or approximately equivalent to a one minute time period, so a final prediction of a 5 minute period of heating (6 minutes, minus the 1 minute equivalent of human subjects addition of heat) may be needed to raise the room temperature. Conversely, as an example, persons skilled in the relevant art(s) would recognize that a system that provides cooling at the above rate may need to run for an additional 1 minute (e.g., a total of 7 minutes) in order to compensate for the human subjects additional heat for the full recovery period to lower the temperature as desired. Thus, step 614 may add or subtract additional time to any recovery period, based on whether cooling or heating is being performed, and may be dependent upon a count of human subjects, or as mentioned previously (a specific thermal impact (or impact of another environmental factor) of human subjects 101, which may depend upon a size and activity level of human subjects 101 as detected by equipment having input to step 604).

Operation proceeds from step 614 to step 616, where environmental control equipment (e.g., an air conditioner, a heater, etc.) is turned on. In step 616, environmental system control is initiated, by providing physical output and control to an environmental system in step 691. Operation proceeds from step 616 to step 618. In step 618, a timer is initiated for reduction. For instance, the calculated time for a recovery period (steps 612 and 614) is used in the timer initiated in step 618, and the timer counts down from this value. In step 622, which follows from step 618, whether the recovery period is over is determined (e.g., whether the timer is finished counting down the recovery period time). In an alternate embodiment, step 616 may be performed prior to, and in anticipation of steps 612 and 614. Re-ordering of these steps in this or any other order is contemplated and is within the spirit and scope of the present invention.

In step 622, as long as the recovery period is not over, additional determinations of whether (and how many) human subjects 101 are present may be performed in step 624. As is indicated earlier, the effect of different human subjects 101, either in number, size, activity level, etc may have a differed impact upon the environmental condition of room 110. So, several conditions may occur from the initial determination in step 604 and the subsequent calculation in step 614. For instance, the humans subjects (a) do not change, (b) completely depart (a count or impact of zero), or (c) change (increase or decrease). Thus, in step 626 (following step 624), the new determination of human subjects 101 of step 624 may be compared to a zero value (in simple count or otherwise environmental impact). If the resulting count or impact is zero, operation proceeds to step 642, where control of the ECS is returned to a zero human impact portion. However, if the human subjects are still non-zero in the room 110, operation proceeds to step 628, where it is determined whether the human subjects in the room determined in step 642 has changed (e.g., increased in number, size, etc., or decreased in number, size, etc.) as compared with a previous determination (from steps 624, 604, or 636). If there is a change detected, operation proceeds from step 628 to step 612, which in turn re-calculates the recovery period. If there is no change in the determination of human subjects, operation proceeds from step 628 to step 622, where the recovery time period is rechecked to determine whether it is over. It is noted that steps 624 and 626 can be reversed in order—checking for a change first, and if so, checking for a zero value afterward. Furthermore, if a continuous mode of operation of the environmental control equipment is not possible or not desired, there may be an impact on step 612 as would be realized to persons skilled in the relevant art(s). For instance, use of less than continuous operation (also known as less than 100% duty cycle), or less than a maximum mode of operation may be accommodated in embodiments, which may potentially increase the recovery time calculated in step 612.

At step 622, if a time period for recovery has expired, operation proceeds to step 632, where a duty for normal environmental factor is calculated. In step 632, the recovery from one or multiple environmental factor(s) has occurred, and it is desired to maintain the target environmental factor(s). The impact of human subjects 101 has been previously calculated in step 614 and may be used in step 632 to determine a less than maximum mode of operating the environmental control equipment (e.g., reducing a load on the equipment in a environmental maintenance mode). Depending upon the type and/or control of the equipment, either a duty cycle, or a reduced rate of operation of the environmental control equipment may be used to maintain the environment (e.g., maintain the temperature, etc.), and not overrun or under run the target environmental factor range, as a result of the presence of human subjects 101 in a room 110. In step 632, based upon the last determination of human subjects 101 (for example, in step 624), a rate of environmental conditioning (e.g., duty cycle, output rate, an amount of heat, an amount of cooling, etc.) needed in order to maintain the environmental factor(s) within a desired range for human comfort may be calculated.

Operation proceeds from step 632 to step 634. In step 634, a duty cycle or a target rate of conditioning of environmental control equipment may be controlled, and this control signal (e.g., a change in duty cycle, output rate, amount of heat, amount of cooling, etc.) may be communicated to the environmental control equipment, as indicated in step 692. Operation may proceed from step 634 to step 636, where in a sustaining mode of operation, one or more sensors may be checked and/or other technique may be performed to determine the human subjects 101 present in the room. Similarly to step 624 (in the recovery mode described above), a result of step 636 may be compared to zero (to determine whether any humans are present) in step 638. In step 639, if in step 638 humans are still present, the result of step 636 may be compared with prior a prior determination, to determine whether a change in the present humans has occurred. In step 638, if it is determined that no humans are present, operation proceeds to step 642. In step 639, if the human subjects 101 determined to be present have not changed, operation proceeds to step 634 to repeat the control of environmental equipment in steps 634 and 692. If however, in step 639, the determination of human subjects 101 is changed (and non-zero), operation proceeds to step 632 for a re-calculation of an environmental conditioning rate (or duty cycle, etc.) in an effort to compensate for the change in human subjects 101.

In step 642, environmental control may be turned off, and operation proceeds to step 644. In step 644, environmental control to a number of zero humans present is made. It is contemplated, but not required, that the environmental control equipment can be turned off for an extended period of time due to the lack of human subjects 101 in room 110. In a zero human presence condition, an extended range of environmental factors may be allowed to occur. As described above, environmental conditioning may be continued to be applied to room 110 in a relaxed range in order to provide a more rapid recovery upon entry of human subjects 101 into room 110 at a future time. In some cases, though, it is contemplated that a complete and indefinite shutdown of equipment could occur, which may optionally occur in steps 642 and 644. When performed, step 644 may provide a control signal that controls the equipment as indicated in step 693, where an output environmental control signal is generated and provided to the equipment (to shut down the equipment, reduce a duty cycle, reduce an output rate, allow a temperature to change, etc.). From step 644, operation may proceed to step 604 to determine a current value for human subjects 101 in room 110 (of FIG. 1).

As such, flowchart 600 FIG. 6 calculates a time for environmental conditioning equipment to impact one, or many, environmental factors within room 110 of interest. A portion of the calculation may rely upon knowledge of the capability of the equipment. In one embodiment, the impact of the environmental conditioning equipment upon an environmental factor, for example heat, and furthermore as measured in BTU, may be a constant as may be expected of a certain manufacturer's equipment as tested or otherwise generally known of the equipment. While this type of estimation may be adequate in some cases, it may be more beneficial for a real assessment of the impact of the environmental conditioning equipment upon the environmental factor, given a particular installation technique, an aging of equipment, and other external environmental factors impacting the ability of the equipment to impact the environmental factor of interest.

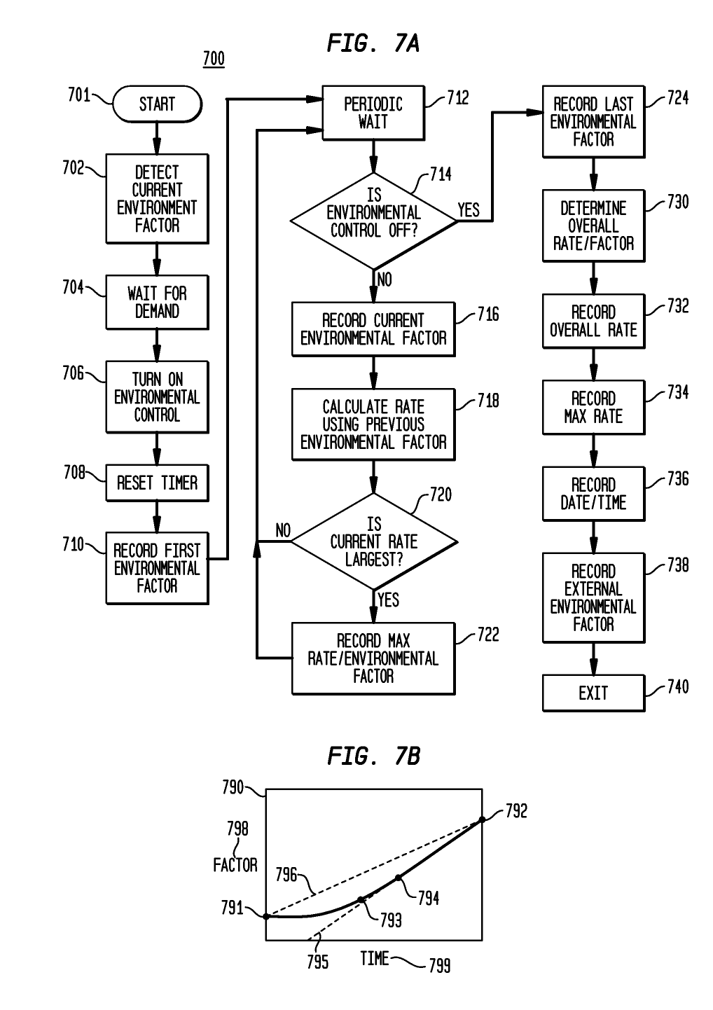

FIG. 7A shows a flowchart 700 providing a process for determining a current capacity or ability of the environmental conditioning equipment to impact one or more environmental factors, according to an embodiment. For instance, in an embodiment, flowchart 700 may be performed by an ECS embodiment described herein, such as ECS 400 of FIG. 4. For example, one or more of sensors 401a-401c, 402, and 403 may be present to perform sensing functions of flowchart 700 and/or described below, including detecting/measuring environmental factors such as measuring temperature, tracking time, measuring CO2 levels, measuring humidity, etc. Furthermore, processing unit 440 of FIG. 4 (e.g., environmental impact processor) may perform calculations, determinations, recording of data, etc., shown in flowchart 700 and/or described below, and may generate controls/control signals to control environmental control equipment as shown in flowchart 600 and/or described as follows. For instance, in an embodiment, processing unit 440 may execute program code configured to perform steps of flowchart 700 and/or operations described below. For purposes of illustration, flowchart 700 and the following description may refer to a common environmental factor—heat. In an embodiment, one or more additional environmental factors may be handled in flowchart 700. Further structural and operational embodiments will be apparent to persons skilled in the relevant art(s) based on the following discussion regarding flowchart 700. It is noted that the steps of flowchart 700 may be performed in other orders than shown in FIG. 7 and described below, and not all of the steps of flowchart 700 need to be performed in all embodiments.

Flowchart 700 begins at start point 701. In step 702, a current environmental factor is measured. For example, a most common environmental factor, heat, may be measured and recorded (e.g., stored in storage, such as a memory device or other storage) in degrees. Additional environmental factors, for example, humidity, CO2, and others may also be measured and recorded. Operation proceeds from step 702 to step 704. In step 704, the algorithm awaits a demand for environmental conditioning. This may be driven by an external means or algorithm, for example. Operation proceeds to step 706, where environmental control is turned on as a result of receiving the demand in step 704. Once the environmental conditioning equipment is turned on in step 706, operation proceeds to step 708. In step 708, a timer is reset. In an alternative embodiment, a current time may be recorded. Operation proceeds from step 708 to step 710. In step 710, a current environmental factor reading is saved/recorded, such as a current temperature in degrees. Operation proceeds from step 710 to step 712.

In step 712, a period of time is waited. As persons skilled in the relevant art(s) would realize, current capabilities of electronics, processing, and the like may be able to take many readings, save, and repeat per second. Flowchart 700 may not require a system that may take more than a few recordings of environmental factors per minute, and may be associated with a system that records any number of environmental factors per minute. Thus, it is contemplated that there may be a reasonable length of time that may be waited in step 712. After this period of time of step 712 elapses, operation proceeds to step 714 to check on the status of the environmental conditioning equipment—e.g., whether environmental control is on or off. If the equipment is still on and operational, operation proceeds from step 714 to step 716. If the equipment is off, operation proceeds from step 714 to step 724.

In step 716, an environmental factor (for example, temperature, etc.) is assessed and recorded. Operation proceeds to step 718 from step 716, where a rate of change of the environmental factor is calculated using the current environmental factor reading and the previous environmental factor reading, as well as the times (relative or absolute) those readings were recorded. For instance, a change in an environmental factor (for example, temperature) may be calculated, and the period of time may be determined for the environmental conditioning equipment to accomplish the change in the environmental factor. The environmental factor change divided by the time period may calculate the rate of change in the environmental factor for that time period. Operation proceeds from step 718 to step 720. In step 720, the current calculated rate of change is compared with a rate of change calculated for a previous time period. If the rate of change has increased (the current rate of change is larger than the previous rate of change), in step 722, the current period's rate of change is recorded as the maximum (largest) rate of change, and operation proceeds to step 712 (to wait for a next time period). In step 720, if the rate of change is not greater, operation proceeds to step 712 (to wait for a next time period). Flowchart 700 repeats steps 712 through 722, continually recording new environmental factor readings, and assessing a maximum rate of change for the period of time the environmental conditioning equipment is turned on.

As mentioned above, when the environmental conditioning equipment is turned off, operation proceeds from step 714 to step 724. In step 724, a last environmental factor reading is recorded, and operation proceeds to step 730. In step 730, similarly to step 718, an overall rate of change is calculated for an entire period of time that the environmental conditioning equipment was active (turned on), and operation proceeds to step 732. In step 732, the rate of change of the entire period is calculated, and operation proceeds to step 734. In step 734, a maximum rate of change is recorded, and operation proceeds to step 736. In step 736, the current absolute date and time is optionally recorded. When assessing the capability of environmental conditioning equipment, external environmental factors may be taken into account, although this is not required. By way of example only, and for one environmental factor—heat—it may be expected that a heat pump, in cooling mode, may be most efficient when the external temperature is cooler than the temperature of room 110, as opposed to warmer. In cases where the external temperature is significantly higher, the heat pump may be less efficient (in cooling mode) in heat transfer to a higher temperature external environment. In addition, it may also be expected that heat may also transfer from the external environment into room 110, which may place an additional heat transfer requirement on achieving a target internal temperature.

In an embodiment, in step 736, the absolute date and time may be recorded to enable a future cross reference to the external environmental factors. Operation proceeds from step 736 to step 738. In step 738, values for the external environmental factor(s), if known at the present time, may also be recorded.

The recording of an absolute date, time, and/or rate of effectiveness may be used to evaluate an efficiency factor of the environmental conditioning equipment. Monitoring of this efficiency factor over time (days, weeks, months, and years) may provide a good indication of the effectiveness of the equipment, and may be used for preventative maintenance, and for proof of efficiency as may be required for compliance to standards in order for a benefit (e.g., compliance to a green building for a tax credit).

FIG. 7B depicts a graph 790 of an environmental factor versus environmental conditioning, according to an example embodiment. Graph 790 is provided to illustrate an example of flowchart 700 of FIG. 7A. For instance, in the example of FIG. 7B, the environmental condition may be heat (shown on the y-axis 798), which is graphed over a given time period (on the x-axis 799) from an initial time at step 710 of FIG. 7A, shown as point 791 in graph 790, through step 724 of FIG. 7A, shown as point 792 in graph 790. At step 706, the environmental conditioning equipment is determined to be on. The sensor of the environmental factor (e.g., a thermometer for measuring heat/temperature, etc.), as well as other system latencies discussed previously, may measure heat. As shown in graph 790, the heat/temperature begins to rise slowly at first. After the environmental conditioning equipment has been in operation for awhile, such as at point 793, the room conditioning may be operating at a most efficient operational mode. This may continue for a period of time, for example from point 793 to point 794, between which the heat continues to rise. For persons skilled in the relevant art(s) based on the teachings herein, it may be apparent that the rate of rise, or fall of an environmental factor, may be most efficient when the slope is the greatest, which in this example as shown between points 793 and 794 (e.g., the slope, or rate, of a curved line 795 from point 791, through points 793 and 794, ending a point 792). The maximum rate of rise, or fall between these points 793 and 794 may be captured in step 722 of flowchart 700. The environmental conditioning equipment may continue to operate for an additional time period until determined to be off at step 714 of flowchart 700, depicted as point 792. An overall efficiency may be additionally deduced between points 791 and 792, the slope, or rate being depicted by a straight line 796. An overall efficiency, indicated as line 796, may take into account a more realistic averaged efficiency for a prediction of a time period to enact a certain change in an environmental factor. As such, a greatest slope of line 791 (maximum rate of change of the environmental factor) may be determined between points 793 and 794 by steps 712-722 of flowchart 700, and an average slope of line 791 (average or overall rate of change of the environmental factor) may be determined by the slope of line 796 between points 791 and 792.

Persons skilled in the relevant art(s) may apply the equation indicated by line 796 to the predicted amount of time for a room to recover from a present state to a properly conditioned state called upon by a human presence, as may be the case in step 612 of FIG. 6. However, the maximum efficiency demonstrated by the line 795 of FIG. 7B may be used to monitor the operating efficiency of the environmental conditioning equipment and used for purposes of dispatching maintenance personnel. In addition, the maximum efficiency may also be used for purposes of monitoring compliance to efficiency guidelines, for example, for an energy credit or other business or governmental reward or financial gain.

Persons skilled in the relevant art(s) of environmental conditioning would realize that the measurements and graphical representations in FIG. 7B may be additionally affected by the external environment, for example by air path 186 shown in FIG. 1. By way of example only, an environmental factor of heat of the external environment indicated by air path 186 may affect the efficiency of environmental conditioning equipment and its ability to change the heat of room 110 of FIG. 1. An efficiency of cooling a room 110, with an external temperature of 70 degrees may be at a higher rate of cooling (more efficient) than the same equipment if faced with an external temperature of, for example 100 degrees. Similarly, an efficiency may be different for a same external temperature, but a time of sunlight (radiant heat passing through a window such as window 103 of FIG. 1) versus darkness (devoid of radiant heat). Similarly, a higher humidity versus a lower humidity of an external environment 186 may affect evaporative chiller cooling environmental conditioning equipment. For purposes of simplistic illustration, these additional variables of an embodiment are not shown. Additional variables affecting the rate or efficiency may be used, in an embodiment. Furthermore, external environmental factors other than heat also apply, such as an exterior environment provided through air path 186, CO2 levels, and air exchange efficiencies, which may differ from one day to the next in the ability to impact the CO2 within a room 110.

In an embodiment referred to as a baseline, FIG. 7B may be utilized by a system at points where relatively few human subjects (including zero) are in room 110. One skilled in the relevant art(s) would realize the impact of the human subjects upon one, many, or all of the environmental factors under monitor or control may be affected, or skewed which may complicate the calculations, and graph 790 of FIG. 7B as well. For the purposes of simplicity, these additional steps, calculations, and impacts of the human subjects upon FIG. 7B are not shown.

In an alternate embodiment, the analysis and capture of the rate of change of environmental factors that includes many human subjects 101 in room 110 may extract the baseline of the embodiment to deduce the operating efficiency or effectiveness for the compensation of the specific number of, or thermal mass of humans 101. This information may be fed back into flowchart 600 of FIG. 6 to adjust, self-adjust, or fine tune the prediction models of the effectiveness of the environmental equipment upon a current number or thermal mass of humans 101. Furthermore, extrapolation from a measured number or thermal mass of humans 101 of the analysis of this alternate embodiment of FIG. 7 can be algorithmically applied to or adjusted to a different number or thermal mass of humans 101 in room 110 of FIG. 1.

Finally, it is important to note that portions of FIG. 7A may be performed within property 100, or as a network service that may be otherwise connected (wired, or wirelessly) to property 100. By way of example only, it may be cost effective to enlist a service that monitors the external environmental factors, such as heat, humidity, radiant sun energy, CO2 levels, etc, and delivers these factors when needed to the environmental conditioning equipment of FIG. 1. Alternatively, an even larger scale of service and cost efficiency may collect the measurement of environmental factors within the building, allowing a service to process these measurements, derive an efficiency formula, and convey the results back to the environmental control equipment at property 100.

### III Example Device Embodiments

Embodiments, including ECS 400, processing unit 440, power module 420, processor 530, OS and algorithm 550, flowchart 600, and flowchart 700 may be implemented in hardware, software, firmware, or any combination thereof. For instance, one or more of ECS 400, processing unit 440, power module 420, processor 530, OS and algorithm 550, flowchart 600, and flowchart 700 may be implemented in a computing device, such as a computer, a special purpose device, etc. For example, ECS 400, power module 420, OS and algorithm 550, flowchart 600, and flowchart 700 may be implemented as computer program code configured to be executed in one or more processors. Alternatively, ECS 400, processing unit 440, power module 420, processor 530, OS and algorithm 550, flowchart 600, and flowchart 700 may be implemented as hardware logic/electrical circuitry. For instance, in an embodiment, one or more of ECS 400, processing unit 440, power module 420, processor 530, OS and algorithm 550, flowchart 600, and flowchart 700 may be implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

Various types of storage may be used in embodiments. Examples of such storage include a hard disk drive for reading from and writing to a hard disk, a magnetic disk drive for reading from or writing to a removable magnetic disk, and an optical disk drive for reading from or writing to a removable optical disk such as a CD ROM, DVD ROM, or other optical media. The drives and their associated computer-readable media provide nonvolatile storage of computer-readable instructions, data structures, program modules and other data for processing (e.g., by processing unit 440, processor 530, etc.). Although a hard disk, a removable magnetic disk and a removable optical disk are described, other types of computer-readable storage media can be used to store data, such as digital video disks and memory devices (e.g., for memory 430, memory 540, etc.), such as flash memory cards, random access memories (RAMs), read only memories (ROM), and the like.

A number of program modules may be stored on the hard disk, magnetic disk, optical disk, ROM, or RAM. These programs include an operating system, one or more application programs, other program modules, and program data. Application programs or program modules may include, for example, computer program logic (e.g., computer program code) for implementing ECS 400, processing unit 440, power module 420, processor 530, OS and algorithm 550, flowchart 600, and flowchart 700 (including any step of flowcharts 600 and 700), and/or further embodiments described herein.

Embodiments may be connected to a network (e.g., the Internet) through an included adaptor or network interface, a modem, or other means for establishing communications over the network. The network interface may be any type of network interface (e.g., network interface card (NIC)), wired or wireless, such as an as IEEE 802.11 wireless LAN (WLAN) wireless interface, a Worldwide Interoperability for Microwave Access (Wi-MAX) interface, an Ethernet interface, a Universal Serial Bus (USB) interface, etc. The network may be any type of communication network, including a local area network (LAN), a wide area network (WAN), a personal area network (PAN), or a combination of communication networks, such as the Internet.

As used herein, the terms “computer program medium,” “computer-readable medium,” and “computer-readable storage medium” are used to generally refer to media such as the hard disk associated with a hard disk drive, a removable magnetic disk, a removable optical disk, as well as other media such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

The invention is also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for environmental system control, comprising:
counting a number of human subjects present within a space;
determining an impact upon an environmental factor by the present human subjects upon the space; and
controlling environmental conditioning equipment based on said determining.

2. The method of claim 1, wherein said counting includes:
performing optical image analysis of a plurality of images of entrances to the space to determine a presence and a direction of travel of one or more human subjects.

3. The method of claim 1, wherein said counting comprises:
performing optical image analysis of a single image of the space to determine a presence of one or more human subjects.

4. The method of claim 1, wherein the environmental factor is heat.

5. The method of claim 1, wherein the environmental factor is humidity.

6. The method of claim 1, wherein the environmental factor is CO2.

7. A method for environmental system control, comprising:
determining a collective impact upon an environmental factor of one or more human subjects present within a space; and
controlling environmental conditioning equipment based on said determining.

8. The method of claim 7, wherein said determining comprises:
performing thermal image analysis of a plurality of images of entrances to the space to determine impact upon an environmental factor and direction of travel of the one or more human subjects.

9. The method of claim 7, wherein said determining comprises:
performing thermal image analysis of a single image of the space to determine a collective impact upon an environmental factor of the one or more human subjects.

10. The method of claim 7, wherein the environmental factor is heat.

11. The method of claim 7, wherein the environmental factor is humidity.

12. The method of claim 7, wherein the environmental factor is CO2.

13. A method for environmental system control, comprising:
determining environmental factor requirements of a plurality of human subjects present within a space; and
controlling environmental conditioning equipment based on said determining.

14. The method of claim 13, wherein said determining comprises:
performing an analysis of one or more thermal images of the plurality of human subjects to determine the environmental factor requirements.

15. The method of claim 13, wherein said determining comprises:
performing an analysis of an activity level of the plurality of human subjects to determine the environmental factor requirements.

16. The method of claim 15, further comprising:
determining the activity level by analysis of a plurality of optical images of the plurality of human subjects.

17. The method of claim 15, further comprising:
determining the activity level by analysis of one or more thermal images of the plurality of human subjects.

18. The method of claim 13, further comprising:
adjusting the environmental factor requirements by additional analysis of external environmental factors incident to the space.

19. The method of claim 18, wherein the external environmental factor is radiant heat.

20. The method of claim 13, wherein the environmental factor is illumination of the space.

21. The method of claim 13, wherein the environmental factor is sound volume of the space.
